(19) United States
(12) Patent Application Publication
(10) Pub. No.: US 2023/0291830 A1
(43) Pub. Date: Sep. 14, 2023

(54) METHODS FOR CALL AND MESSAGE HANDLING

(71) Applicant: Zhenkun Wang, Marblehead, MA (US)

(72) Inventor: Zhenkun Wang, Marblehead, MA (US)

(21) Appl. No.: 17/717,945

(22) Filed: Apr. 11, 2022

(30) Foreign Application Priority Data
Mar. 9, 2022 (CN) 202210221005.1

(51) Int. Cl. H04M 3/42; H04M 3/436; H04M 1/27453

(52) U.S. Cl. CPC H04M 3/42042; H04M 3/436; H04M 1/27453

(57) ABSTRACT

A call handling method is provided. The call handling method, comprising receiving a notification of a call with a caller id number; searching for a first contact tuple corresponding to the caller id number in a filter book; determining whether a category of the first contact tuple is denoted as normal when the contact tuple is found; and prompting a user to answer the call when the category of the contact tuple is not denoted as normal.

### FIELD OF THE INVENTION

The present invention relates to telephonic filter, and more particularly, to a configurable telephonic filter.

### BACKGROUND OF THE INVENTION

Telephonic conversations and message exchanges are daily activities. More and more harassing, advertisement or even fraud calls and messages seriously disrupt normal life and work. Precious time and plausible economic loss in answering the calls and messages.

Therefore, there exists a desire to have a telephonic filter to screen out unwanted incoming calls and messages. People can actively and promptly manage the incoming communications via the telephonic filter and treat their smart phones as safe communication tools.

### SUMMARY OF THE INVENTION

An objective of the present application is to provide a filter application for filtering calls and messages from unexpected callers while preserving flexibility to receive calls and messages if passwords are provided from callers. Harassing, advertising or fraud calls and messages can be filtered by the methods provided by the present application. Precious time is also saved, too. Thus, people can actively and promptly manage the incoming communications via the telephonic filter and treat their smart phones as safe communication tools.

According to an embodiment of the present application, a call handling method is provided. The call handling method comprising receiving a notification of a call with a caller id number; searching for a first contact tuple corresponding to the caller id number in a filter book; determining whether a category of the first contact tuple is denoted as normal when the contact tuple is found; and prompting a user to answer the call when the category of the contact tuple is not denoted as normal.

According to an embodiment of the present application, a message handling method is provided. The message handling method comprising receiving a message with a caller id number; searching for a first contact tuple according to the caller id number in a filter book; determining whether a category of the first contact tuple is denoted as normal when the contact tuple is found; and prompting a user with the message when the category of the contact tuple is not denoted as normal.

### BRIEF DESCRIPTION OF THE DRAWINGS

The advantages and spirit related to the present invention can be further understood via the following detailed description and drawings.

FIG. 1 illustrates a block diagram of a communication apparatus 100 in accordance with an embodiment of the present invention.

FIG. 2 shows an example of a logical data structure of a filter book 200 in accordance with an embodiment of the present application.

FIG. 3 shows an example of a logical data structure of a filter book 200 and a contact book 300 in accordance with an embodiment of the present application.

FIG. 4 depicts a flowchart diagram of an initialization method of a filter application in accordance with an embodiment of the present application.

FIG. 5 illustrates a flowchart diagram of a call handling method in accordance with an embodiment of the present application.

FIG. 6 illustrates a flowchart diagram of a message handling method in accordance with an embodiment of the present application.

FIG. 7 depicts a flowchart diagram of a contact information management method in accordance with an embodiment of the present application.

### DETAILED DESCRIPTION OF THE PREFERRED EMBODIMENT

Some embodiments of the present application are described in details below. However, in addition to the description given below, the present invention can be applicable to other embodiments, and the scope of the present invention is not limited by such rather by the scope of the claims. Moreover, for better understanding and clarity of the description, some components in the drawings may not necessary be drawn to scale, in which some may be exaggerated related to others, and irrelevant. If no relation of two steps is described, their execution order is not bound by the sequence as shown in the flowchart diagram.

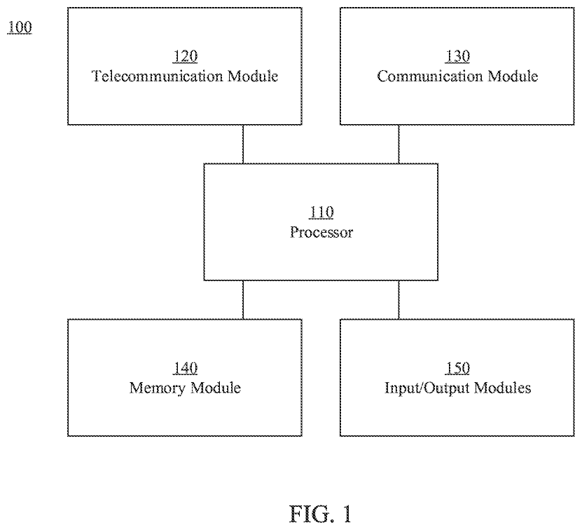

Please refer to FIG. 1 which illustrates a block diagram of a communication apparatus 100 in accordance with an embodiment of the present invention. This communication apparatus 100 may be usually referred as a smart phone which runs an operating system and application programs. As shown in FIG. 1, the communication apparatus 100 may comprise a processor 110 for controlling operations of the communication apparatus 100, one or more telecommunication modules 120 for connecting to wireless telecommunication services, one or more communication modules 130 for connecting to wireless or wired communication service, a memory module 140 for storing instructions and data being operated by the processor 110 and one or more input/output modules 150 for receiving input from an user of the communication apparatus 100 or for outputting signals to the user.

In one embodiment, the telecommunication module 120 may include hardware modules such as antenna, amplifier, filter, and modem for transmitting and receiving signals to wireless telecommunication services such as 2G, 3G, 4G, 5G and 6G industrial standard compliance networks and proprietary standard networks like Inmarsat and Starlink. via the telecommunication module 120, services such as audio and video telephonic service, text message service, multimedia message service and/or data service are provided to the communication apparatus 100. The telecommunication module 120 may include analog front-end processing circuits and digital back-end processing circuits. The analog and digital circuits may include antennas, filters, operational amplifiers, power amplifiers, regulators, sampling circuits, dc-dc converters, delay circuits, embedded digital signal processors and associated firmware and memory. Person having ordinary skill in the art may have knowledges of telecommunication background to enable incorporations of the circuits for realizing the telecommunication module 120.

A universal unique subscriber number may be associated with a telecommunication service. In most cases, the subscriber number is represented or corresponding to a telephone number. When attaching to the subscribed telecommunication service via the telecommunication module 120, another communication apparatus 100 can initiate an audio/video call or send message to this communication apparatus 100 which is represented by the universal unique subscriber number or the telephone number. Reversely, this communication apparatus 100 can initiate an audio/video call or send message to another communication apparatus 100 which is also represented by another universal unique subscriber number or another telephone number. Usually, the caller would allow the telecommunication service provider to forward the subscriber number or the telephone number to the callee. The callee can decide to answer or to reject the call according to the forwarded subscriber number or the telephone number. For convenience, in the present application, the universal unique subscriber number or the telephone number are referred as an id number.

In one embodiment, the communication module 130 may include hardware modules such as antenna, amplifier, filter, and modem for transmitting and receiving signals to wireless or wired communication apparatus. The communication module 130 may follow local area network industrial standards such as IEEE 802.3, IEEE 802.11, and IEEE 1394 or pico/personal area network industrial standards such as Bluetooth, Near Field Communication and IrDA. Sometimes, the communication apparatus 100 can access Internet via the communication module 130 and the connected network. The communication module 130 may include analog front-end processing circuits and digital back-end processing circuits. The analog and digital circuits may include antennas, filters, operational amplifiers, power amplifiers, regulators, sampling circuits, dc-dc converters, delay circuits, embedded digital signal processors and associated firmware and memory. Person having ordinary skill in the art may have knowledges of communication background to enable incorporations of the circuits for realizing the communication module 130.

In one embodiment, the memory module 140 may include volatile and non-volatile memories such as static random-access memory, dynamic random-access memory, EEPROM, flash ROM and/or any other persistent or non-persistent memory media. Instructions and data are stored in the memory module 140. The type of the input/output module 150 may be switch, button, keyboard, mouse, touch panel, touch screen, display, light, speaker, microphone, camera, vibrator or Global Navigational Satellite Services receiver etc. Under the control of the processor 110, the input/output modules 150 are configured to receiving input from a user of the communication apparatus 100 or for outputting signals to the user.

Usually, three application programs including an audio/video call program, a message program and a contact book program are default installed in the communication apparatus 100. All of these share a common contact book stored in the memory module 140. There are tuples in the contact book. In each tuple, a contact information including a name of the contact and the id number are recorded. Optional information related to the contact such as address, email address, tile, birthday may be also put into the same tuple. The contact book program is supposed to manage the tuples. Operations include add, delete, search, and modify on the tuples are manipulated by the contact book program following the user's commands. The call program and the message program also take advantage of the tuples in the contact book for taking a call/message to or receiving a call/message from a contact tuple. Of course, the call program and the message program are also supposed to handle calls and messages from and to those id numbers missed in the contact book.

The present application provides a filter application program in accordance with an embodiment. The filter application program is supposed to be run under the operating system environment of the communication apparatus 100. After being installed, the filter application program begins an initial configuration step to learn about information of the particular communication apparatus 100. Some or all of the required information may be provided automatically by the operating system run by the communication apparatus 100 or be inputted by the user of the communication apparatus 100 via the input/output modules 150. Besides, the filter application also requests privileges to access the original contact book and to access the telecommunication module 120. Once the requested privileges are granted, the filter application can operate to filter incoming calls and messages.

For examples, the information may include a username, one or more id numbers associated with the communication apparatus 100 and/or one or more postal zip codes where the communication apparatus 100 resides. The username and the id numbers may be collected by inquiry to the operating system. Once the zip codes are collected, the filter application may access an online information database to download id numbers of local authorities, local public services such as police departments and fire departments, emergency services and utility service providers according to the collected zip codes. In an embodiment, in case the input/output modules 150 and/or the telecommunication module 120 can provide a geographical location of the communication apparatus 100. The filter application may also access an online information database or a search engine to download or to search the aforementioned id numbers according to the acquired geographical location. Because the communication apparatus 100 may move, the filter application may automatically and/or periodically detect the change of the location and update the id numbers.

In one embodiment, the id numbers acquired by the filter application from Internet may be stored in a filter book which resides in the memory module 140. Like the contact book, the filter book maintained by the filter application may be used to store tuples of contacts. In one embodiment, the entire content of the contact book is copied to the empty filter book when the filter application is initiated. For each tuple of the filter book, it may include an id number as the index key of the tuple. Since the id number of a contact is unique, the index keys of any given two tuples are different. A tuple may include information such as contact name, title, address, email address, birthday and etc. The kind of information of a tuple of the filter book may be copied from a corresponding tuple of the contact book

An additional category attribute and a password field are assigned to a tuple of the filter book. For example, contacts corresponding to those id numbers acquired from Internet may be assigned to a “system” category. Contacts assigned to the “system” category have their password fields vacant. Or passwords corresponding to the contacts assigned to the “system” category are disregarded. No matter whatever stored in the password fields corresponding to the system category, they are not concerned.

In an alternative embodiment, a tuple of the filter book does not store the information which can be found the corresponding tuple of the contact book except for the index key, i.e., the id number. According to the id number, the filter application can find information of a contact in a contact book. Meanwhile, the original three application programs, i.e., the call program, the message program and the contact book program, can operate on the shared common contact book as usual. And the filter application can operate on the proprietary filter book and the shared common contact book if the filter application is granted to access the contact book.

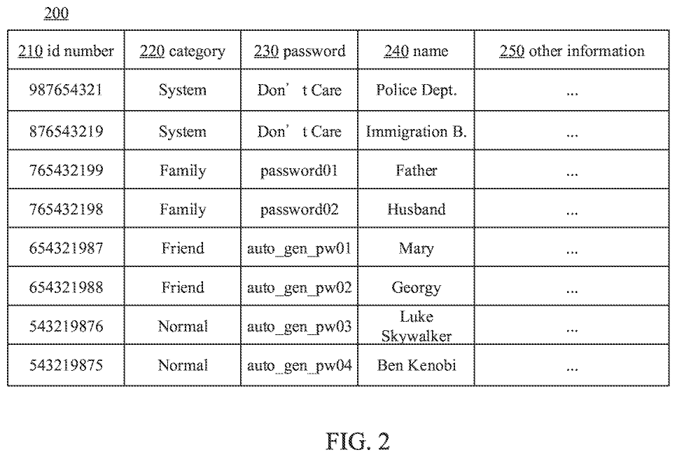

Please refer to FIG. 2, which shows an example of a logical data structure of a filter book 200 in accordance with an embodiment of the present application. During initialization, the filter application copies content of the contact book to the filter book 200. As shown in FIG. 2, there are 8 tuples of contacts in the filter book 200. After the initial copy operation, the last six tuples, i.e., Father, Husband, Mary, Georgy, Luke Skywalker and Ben Kenobi, are duplicated from the contact book while leaving the category and the password fields empty. Then the filter application asks the user to classify these six contacts. In response, as shown in FIG. 2, the user of the communication apparatus 100 classifies the contacts Father and Husband into a Family category, the contacts Mary and Georgy into a Friend category and the rest two contacts Luke and Ben into a Normal category.

For the two tuples classified as “Family” categories, the filter application also asks the user to input passwords, respectively. For the four tuples classified as “Friend” and “Normal” category, the filter application may automatically generate passwords for the “Friend” and “Normal” contacts. Moreover, as iterated above, the filter application acquires first two “System” contacts, Police Dept. and Immigration B., from Internet and creates two corresponding tuples classified as “System” category.

In one embodiment, because traditional telephone dial pad includes 10 digits (0˜9), and two symbols, i.e., star (*) and sharp (#), the passwords 230 may be constituted by a concatenation of these 12 symbols. This means that the filter application may impose a formality check to enforce the rule. For those automatically generated passwords corresponding to the “Normal” contact tuples, the filter application may further ensure the generated passwords are unique in the filter book. In other words, any given two passwords are not identical. Moreover, the automatic generation of password may consider the number of tuples of the filter book to set the length of the passwords. The larger the number of tuples, the longer the length of the generated password. If a new password input by the user is identical to an existed password, the filter application may ask the user to try a new one.

In alternative embodiment, digits of the dial pad represent several English characters. For examples, digit number “2” is corresponding to English characters “A”, “B” and “C”. Digit number “9” is corresponding to English characters “W”, “X”, “Y” and “Z”. the passwords 230 may be constituted by a concatenation of 26 English characters. In case the user wants to input “Father” as the password, he may input the case-sensitive or case-insensitive six English characters via traditional keyboard application provided by the operating system of the communication apparatus 100. Or alternatively via traditional telephone pad, he may input six digit dials “3”, “1”, “8”, “4”, “3” and “7” to represent “F”, “a”, “t”, “h”, “e”, and “r” respectively. Moreover, in another case, he may input digit dials “333” (“F”), “2” (“a”), “8” (“t”), “44” (“h”), “33” (“e”) and “777” (“r”).

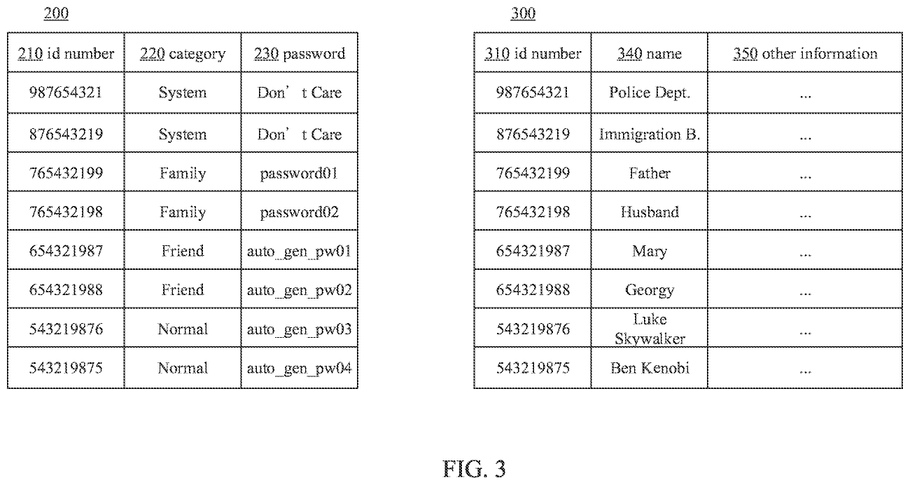

Please refer to FIG. 3, which shows an example of a logical data structure of a filter book 200 and a contact book 300 in accordance with an embodiment of the present application. Unlike the embodiment as shown in FIG. 2, during initialization, the filter application does not copy content of the contact book 300 to the filter book 200. Instead, the filter application keeps the contact book 300 intact. A new filter book 200 is created. After that, the id numbers 310 of the last six tuples, i.e., Father, Husband, Mary, Georgy, Luke Skywalker and Ben Kenobi, are duplicated from the contact book 300 to the corresponding tuples of the contact book 200 while leaving the category and the password fields 220 and 230 empty. Then the filter application asks the user to classify these six contacts. In response, as shown in FIG. 3, the user of the communication apparatus 100 classifies the contacts corresponding to Father and Husband tuples of the contact book 300 into a Family category, the contacts corresponding to Mary and Georgy tuples of the contact book 300 into a Friend category and the rest two contacts Luke and Ben tuples of the contact book 300 into a “Normal” category.

For the two tuples classified as “Family” categories, the filter application also asks the user to input passwords, respectively. For the four tuples classified as “Friend” and “Normal” category, the filter application may automatically generate passwords for the “Friend” and “Normal” contacts. Moreover, as iterated above, the filter application acquires first two “System” contacts, Police Dept. and Immigration B., from Internet and creates two corresponding tuples classified as “System” category. Information of these two “System” tuples is not recorded in the first two tuples of the filter book 200. Instead, the information of these two “System” contacts is added to the first two tuples of the contact book 300. Thus, the three original application programs can make uses of these two newly added tuples of the contact book 300 without any problem, too.

Besides, there may exist some embodiments that the original contact book allows the filter application to append columns to the contact tuples. Thus, the appended columns may be used to store passwords and categories of existed contacts by the filter application. The original application programs, i.e., the caller program, the message program and the contact book management program can make use of the original columns of the contact book. The filter application can add “System” contacts to the contact book.

Anyway, the present application does not limit how to implement the data structures of contacts if a category and/or a password can be associated with a contact. The manipulations of contents of the data structures have no side effects made by the filter application.

Person having ordinary skill in the art may understand that the data structures of filter books as shown in FIGS. 2 and 3 are merely exemplary. Additional fields or columns may be added to each contact tuples. For examples, some or all of following data may be recorded for each contact tuples: a creation time, a latest modified time, an expiry date, a number of incoming calls, a number of outgoing calls, outgoing password, a latest incoming call time, a latest outgoing call time, a latest incoming message time, a latest outgoing message time and etc. The fields or columns of the filter books as shown in FIGS. 2 and 3 are not used to limit the scope of the present application.

In addition to the data structures of filter books as shown in FIGS. 2 and 3, the filter application may maintain other data structures to support its functions. For example, a rejection list may be used to include all id numbers that are prohibited permanently. In another example, a handling history may be used to record the processes of each call and/or message.

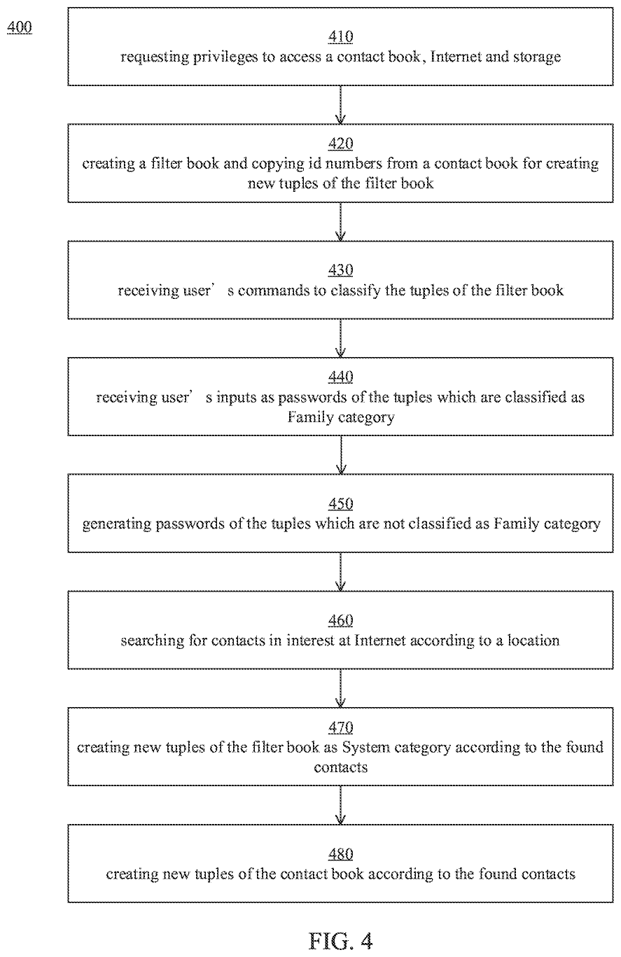

Please refer to FIG. 4, which depicts a flowchart diagram of an initialization method of a filter application in accordance with an embodiment of the present application. This initialization method 400 may be implemented as instructions to be executed by the processor 110 of the communication apparatus 100 as shown in FIG. 1. The instructions and associated data of the filter application may be stored in the memory module 140. The initialization method 400 may begin at step 410. The present application does not limit execution order of any given two steps unless they have causal or dependent relationship.
Step 410: requesting privileges to access a contact book, Internet and storage. The operating system of the communication apparatus 100 may not grant any privileges to any newly installed application program. Thus, the newly installed filter application may need to request privileges to access the contact book for accessing existing contacts, to access Internet for searching the “System” contacts information and to access storage for persisting data. The access privileges may be granted by a user or the operating system of the communication apparatus 100.
Step 420: creating a filter book and copying id numbers from a contact book for creating new tuples of the filter book. The filter book created may be as shown in either one of the filter books 200 as shown in FIG. 2 and FIG. 3.
Step 430: receiving user's commands to classify the tuples of the filter book. As described above, there may exist three categories for existing contacts. The categories include “Family”, “Friend” and “Normal”. In an alternative embodiment, the categories may be represented by a number. For example, the three categories are represented by 1, 2 and 3, respectively.
Step 440: receiving user's inputs as password of the tuples which are classified as “Family” category.
Step 450: generating passwords of the tuples which are not classified as “Family” category. As described above, the generated password may be unique. And their lengths and character set may be configurable or predetermined. The generation may be in random or in pseudo random.
Step 460: searching for contacts in interest at Internet according to a location of the communication apparatus 100. The location of the communication apparatus 100 may be inputted by the user or may be acquired by one or more sensors of the communication apparatus 100.
Step 470: creating new tuples of the filter book as “System” category according to the found contacts. In case the filter book includes contact information as shown in FIG. 2, the flow does not proceed to optional step 480 after the step 470 is done. In case the filter book includes contact information as shown in FIG. 3, the flow may proceed to step 480 after the step 470 is done.
Optional step 480: creating new tuples of the contact book as “System” category according to the found contacts.

During the installation and initiation, the filter application may be set as a default application program to handle incoming calls and/or messages. After the filter application is installed and initialized, the filter application may be resided in system memory and constantly ready for handling incoming calls or messages. When the telecommunication module 120 or the communication module 130 is notified that an audio/video call is incoming with a caller id number, this call incoming notification and the caller id number is provided to the filter application. Therefore, a call handling method provided by the present application is implemented by the filter application for handling this call.

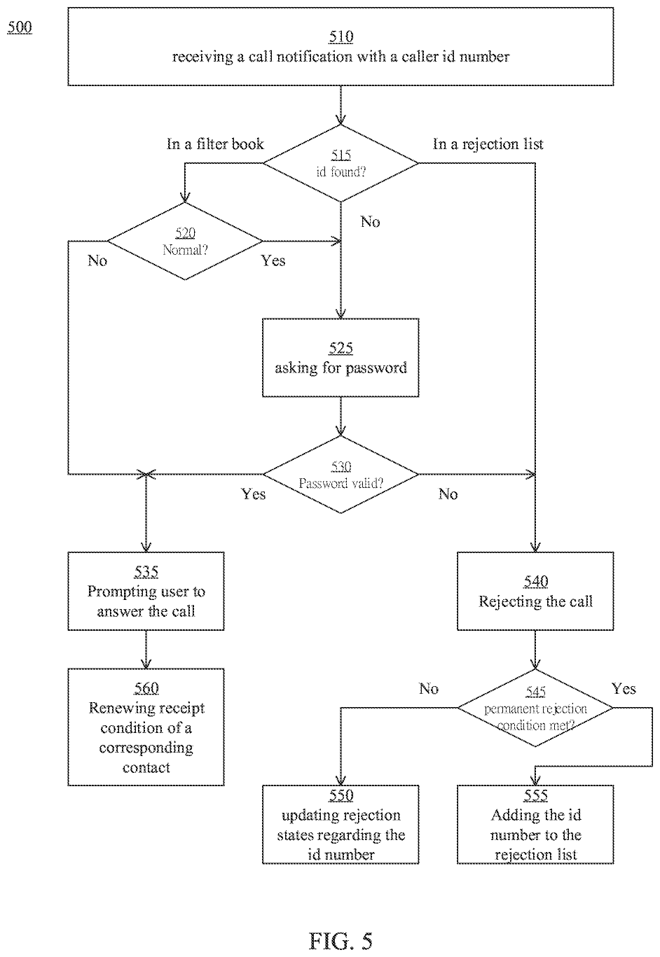

Please refer to FIG. 5, which illustrates a flowchart diagram of a call handling method in accordance with an embodiment of the present application. The call handling method 500 is configured to deal with an audio/video call which needs immediate attention of the callee. The call handling method 500 begins at step 510.
Step 510: receiving an audio/video call notification with a caller id number. The flow proceeds to step 515.
Step 515: searching for the caller id number in the filter book. In an alternative embodiment, the step further optionally comprises searching for the caller id number in a rejection list. If the caller id number is found in the rejection list, the flow may proceed to step 540. If the caller id number is found in the filter book, the flow may proceed to step 520. If the caller id number is not found in the filter book and the rejection list, the flow may proceed to step 525.
Step 520: checking whether the caller id number belongs to a tuple classified with “Normal” category. In case the caller id number belongs to a “Normal” contact, the flow may proceed to step 525. When the caller id number belongs to a “System”, “Family” or “Friend” contact, the flow may proceed to step 535.
Step 525: asking the caller for password. Since the filter application cannot find the caller id number in the filter book, the caller may be a Family or a Friend who uses communication apparatus 100 with unknown id number to initiate the call. In this circumstance, the filter application may ask the caller to input his/her assigned password. In one embodiment, the filter application may need to pick up the call first then prompt the caller to input password via a dial pad or a keyboard. Although the call is pick up by the filter application, the callee user is not alerted. In one example, when the caller inputs the password via the dial pad, the digits are modulated by well-known DTMF (dual tone multiple frequency). The filter application can demodulate the sound signals to get the digits input by the caller. In an alternative embodiment, the filter application may send out-of-band message to ask for the caller to input password. After receiving a password from the caller or a time out event for receiving the password is brought up, the flow may proceed to step 530.
Step 530: checking whether the received password is valid. When the received password is valid, i.e., the received password can be found in the filter book, the flow may proceed to step 535. When the received password is not valid or expired, the flow may proceed to step 540.
Step 535: prompting the user to answer the call. The filter book may present contact information regarding to the found caller id number/password to the user. The user may decide whether to take the call from a known caller. Of course, the user may not answer this call due to various reasons. The flow may proceed to an optional step 560 if the caller belongs to “Normal” contact.
Step 540: rejecting the call. In one embodiment, the filter application may reject the call promptly. In another embodiment, the filter application may disconnect the call after receiving password from the caller. After step 540, the flow may proceed to optional step 545.
Step 545: determining whether a permanent rejection condition regarding the caller id number is met. For example, the user may set up a condition that if calls from an unknown id number are received five times a day, this unknown id number would be rejected permanently. When a permanent rejection condition is met, the flow may proceed to step 555. Otherwise, the flow may proceed to step 550.
Step 550: updating rejection states regarding the id number. For example, when the call came from an unknown id number, the step 550 would update the number of calls regarding the unknown id number by increasing one.
Step 555: adding the id number to the rejection list.
Step 560: renewing receipt condition of a corresponding contact. In one embodiment, the user may configure a maximum number of successful calls regarding a contact, which is usually classified as the “Normal” category. After a successful call is complete, the flow implemented by the filter application may update the number of successful calls regarding the contact. If the number of successful calls matches with the maximum number, the filter application may ask the user for resetting the number of successful calls or increasing the maximum number of successful calls. If the user agrees to reset the number of successful calls or to increase the maximum number of successful calls, the password of the corresponding contact is set valid. If the user does not agree to renewing the receipt condition of the corresponding contact, the password of the corresponding contact is set invalid. In another embodiment, the user may configure an expiry date regarding a corresponding contact, which is usually classified as the “Normal” category. After a successful call is complete, the filter application may update the expiry date according to the date of the latest successful call. For example, an expiry date may be set as one day, one week, or one month from the latest successful call.

In one embodiment, a contact with an expired password may have one chance to renew its receipt condition. When the filter application finds the caller id number in the filter book and the caller inputs a correct and expired password, the filter application may ask the user how to deal with this contact. An option may be offered to the user is to reset the receipt condition to set the password valid. Another option may include extending the expiry date. The user may choose to reject the caller contact by placing this contact into the rejection list. Or the user just leaves the same question intact and let it happens again next time the same contact calls.

In one embodiment, if the user realizes a password recorded in the filter book is leaked unintentionally, the user may reassign a new and unique password or ask the filter application to automatically generate another new and unique password for the corresponding contact. Alternatively, the user may put the id number corresponding to the leaked password in the rejection list. Thus, the user of the communication apparatus 100 may be harassed once and only once from the contact.

In one embodiment, the call handling method 500 may further records how it process each call. The user can check details of the call processes. The information may include the caller id number, receiving time of the call, and/or result of process.

If a Family member initiates a call with an id number recorded in a “Family” tuple of the filter book, the flow as shown in FIG. 5 may go through steps 510, 515, 520 and 535. The Family member does not need to input the password and the user would receive a prompt from the filter application. If a Family member initiates a call with an unknown id number, the flow as shown in FIG. 5 may go through steps 510, 515, 525 and 530. When the Family member inputs a correct password in the corresponding tuple of the filter book, the flow may proceed to step 535.

If a Friend initiates a call with an id number recorded in a “Friend” tuple of the filter book, the flow as shown in FIG. 5 may go through steps 510, 515, 520 and 535. The Friend does not need to input the password and the user would receive a prompt from the filter application. If a Friend initiates a call with an unknown id number, the flow as shown in FIG. 5 may go through steps 510, 515, 525 and 530. When the Friend inputs a correct password in the corresponding tuple of the filter book, the flow may proceed to step 535.

If a “Normal” person initiates a call with an id number recorded in a “Normal” tuple of the filter book, the flow as shown in FIG. 5 may go through steps 510, 515, 520, 525 and 530. The Normal person would need to input the password and the user would receive a prompt from the filter application at step 535. If a “Normal” person initiates a call with an unknown id number, flow as shown in FIG. 5 may still go through steps 510, 515, 520, 525 and 530. The Normal person would need to input the password and the user would receive a prompt from the filter application at step 535.

If a “System” person initiates a call with an id number recorded in a “System” tuple of the filter book, the flow as shown in FIG. 5 may go through steps 510, 515, 520 and 535. The caller does not need to input the password and the user would receive a prompt from the filter application.

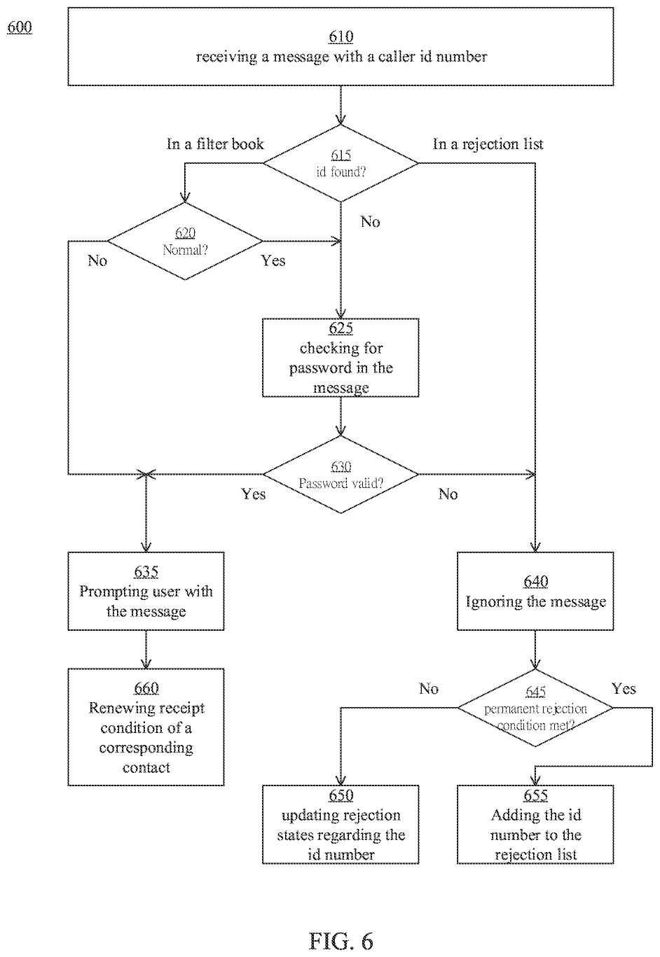

Please refer to FIG. 6, which illustrates a flowchart diagram of a message handling method 600 in accordance with an embodiment of the present application. Like the call handling method 500, the message handling method 600 to configured to deal with a message from the “caller”. No matter what its content includes, e.g., text, image, and/or audio/video clip, a message includes an id number of the “caller”.
Step 610: receiving a message with a caller id number. The flow proceeds to step 615.
Step 615: searching for the caller id number in the filter book. In an alternative embodiment, the step further optionally comprises searching for the caller id number in a rejection list. If the caller id number is found in the rejection list, the flow may proceed to step 640. If the caller id number is found in the filter book, the flow may proceed to step 620. If the caller id number is not found in the filter book and the rejection list, the flow may proceed to step 625.
Step 620: checking whether the caller id number belongs to a tuple classified with “Normal” category. In case the caller id number belongs to a “Normal” contact, the flow may proceed to step 625. When the caller id number belongs to a “System”, “Family” or “Friend” contact, the flow may proceed to step 635.
Step 625: checking for password in the message. Since the filter application cannot find the caller id number in the filter book, the caller may be a Family or a Friend who uses communication apparatus 100 with unknown id number to send the message. In this circumstance, the filter application may check whether the content of the message includes an assigned password. For example, the password may be placed in the head or in the rear of the message. The flow may proceed to step 630.
Step 630: checking whether the received password is valid. When the received password is presented and valid, i.e., the received password can be found in the filter book, the flow may proceed to step 635. When the received password is not valid or expired, the flow may proceed to step 640.
Step 635: prompting the user with the message. The filter book may present contact information regarding to the found caller id number/password to the user. The user may decide to read or to play the message. The flow may proceed to an optional step 560 if the caller belongs to “Normal” contact.
Step 640: ignoring the message. In one embodiment, the filter application may delete the message automatically. In another embodiment, the filter application may hide the message or place the message in a trash box. After step 640, the flow may proceed to optional step 645.
Step 645: determining whether a permanent rejection condition regarding the caller id number is met. For example, the user may set up a condition that if messages from an unknown id number are received five times a day, this unknown id number would be rejected permanently. When a permanent rejection condition is met, the flow may proceed to step 655. Otherwise, the flow may proceed to step 650.
Step 650: updating rejection states regarding the id number. For example, when the message came from an unknown id number, the step 650 would update the number of messages regarding the unknown id number by increasing one.
Step 655: adding the id number to the rejection list.
Step 660: renewing receipt condition of a corresponding contact. In one embodiment, the user may configure a maximum number of messages regarding a contact, which is usually classified as the “Normal” category. After a message is received, the flow implemented by the filter application may update the number of messages regarding the contact. If the number of messages matches with the maximum number, the filter application may ask the user for resetting the number of messages or increasing the maximum number of messages. If the user agrees to reset the number of messages or to increase the maximum number of messages, the password of the corresponding contact is set valid. If the user does not agree to renewing the receipt condition of the corresponding contact, the password of the corresponding contact is set invalid. In another embodiment, the user may configure an expiry date regarding a corresponding contact, which is usually classified as the “Normal” category. After a message is received, the filter application may update the expiry date according to the date of the latest message. For example, an expiry date may be set as one day, one week, or one month from the latest message.

In one embodiment, the message handling method 600 may further records how it process each message. The user can check details of the message processes. The information may include the caller id number, receiving time of the message, and/or result of process.

If the user of the filter application wants to receive a call or a message from a “Normal” person, the user may add a new tuple classified as “Normal” category with an automatically generated password and leave the id number vacant. Moreover, the user wants to call the Normal person, the exact id number of the Normal person may be recorded in the newly created tuple.

The same filter application may be installed in two communication apparatuses 100. These two instances of the filter applications may participate a handshake protocol to create “Normal” contact tuples for each other, respectively. For example, a first instance of the filter application runs at a first communication apparatus 100A creates a second contact tuple of a second communication apparatus 100B. Similarly, the second instance of the filter application runs at the communication apparatus 100B also creates a first contact tuple of the first communication apparatus 100A. The second contact tuple includes a second id number corresponding to the second communication apparatus 100B. Similarly, the first contact tuple includes a first id number corresponding to the first communication apparatus 100A. In one example, a common password is shared by the first contact tuple and the second contact tuple.

In one embodiment, the contact tuple includes not only an incoming password but also an outgoing password. The filter application may be also used to initiate a call according to a contact tuple of the filter book. By practicing aforementioned handshake protocol between two instances of the filter application runs on two different communication apparatus 100A and 100B, the common password is recorded in the incoming password and the outgoing password of both the first and the second contact tuples. Alternatively, an instance of the filter application may generate a password stored as the incoming password field and send the generated password to its counterpart. After receiving the password from its counterpart, the instance would record the received password as the outgoing password of the corresponding contact tuple. In addition to the passwords, two instances of the filter application may exchange their id number and contact information.

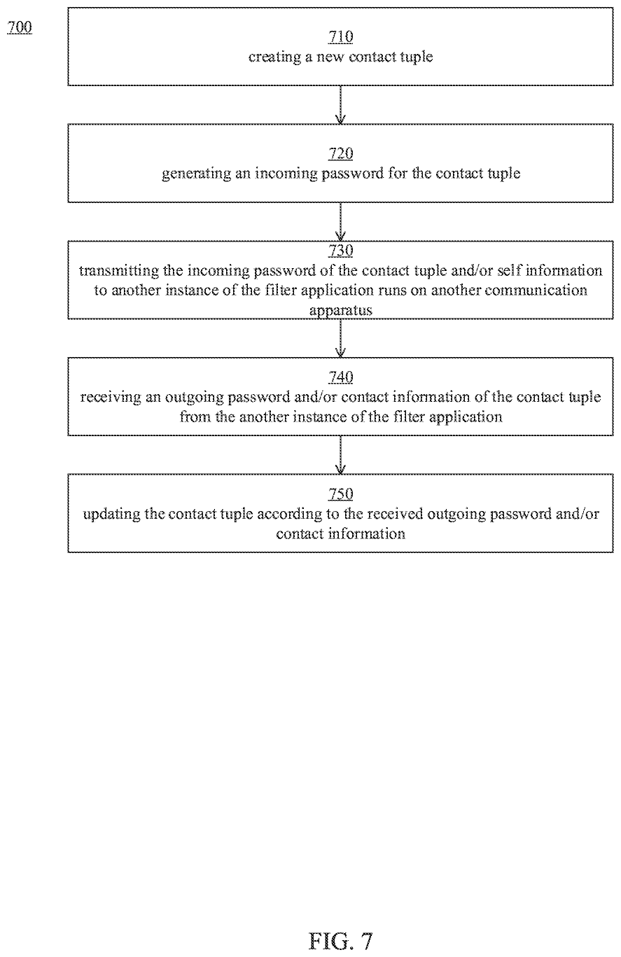

Please refer to FIG. 7, which is a flowchart diagram of a contact information management method 700 in accordance with an embodiment of the present application. The contact information management method 700 may be implemented by the filter application after it is installed and initialized. The contact information management method 700 begins with step 710.
Step 710: creating a new contact tuple in the filter book. Usually, the new contact tuple may be classified as Normal category by default. In one embodiment, either an id number or a name of the contact tuple may be required when the creation of the new contact tuple. In other words, the new contact tuple may have a null id number or a null name.
Step 720: generating an incoming password of the contact tuple. The password of the contact tuple may be automatically generated as described above in order to guarantee its uniqueness.
Step 730: transmitting the incoming password of the contact tuple and/or self-information to another instance of the filter application runs on another communication apparatus. If the communication apparatus implementing this method 700 and another communication apparatus can connect to each other directly, they may exchange information directly. For example, these two communication apparatuses may be attached to a same wireless local area network such as Bluetooth or Wireless LAN, or they are connected via a pear-to-pear link such as NFC or USB. These two instances of the filter application can look for its counterpart in the local area network or look for its peer in the link. Once they recognize the existence of each other, information can be exchanged according to a protocol. Alternatively, these two communication apparatuses may attach or connect to a server indirectly for exchanging information. The present application does not limit how these two instances of the filter application exchange information.

In addition to the password, the user may want to share self-information to the counterpart. For example, the self-information may include but not limit to the id number, the name, and etc. If anything the user wants the counterpart to know, the information can be also transmitted at step 730.

The method 700 may end at step 730 if the user does not want to initiate call to the person corresponding to the contact tuple. However, in case that the user wants to initiate call to the person corresponding to the contact tuple, this instance of the filter application needs to note the password required by another instance of the filter application. Thus, the flow may proceed to step 740.

Optional step 740: receiving an outgoing password and/or contact information of the contact tuple from the another instance of the filter application. This step 740 implemented by this instance of the filter application is corresponding to the step 730 implemented by another instance of the filter application. Thus, the present application does not limit the execution order of these two steps 730 and 740.

Optional step 750: updating the contact tuple according to the received outgoing password and/or contact information.

According to an embodiment of the present application, a call handling method is provided. The call handling method comprising: receiving a notification of a call with a caller id number; searching for a first contact tuple corresponding to the caller id number in a filter book; determining whether a category of the first contact tuple is denoted as normal when the contact tuple is found; and prompting a user to answer the call when the category of the contact tuple is not denoted as normal.

Preferably, in order to receive call by checking password, the call handling method further comprises: asking a caller for a password when no contact tuple corresponding to the caller id number in the filter book is found; searching for a second contact tuple corresponding to the password from the caller in the filter book; prompting the user to answer the call when the second contact tuple corresponding to the password is found; and rejecting the call when the second contact tuple corresponding to the password is not found.

Preferably, in order to reject a caller id number permanently, the call handling method further comprises: determining whether the caller id number is in a rejection list prior to the searching step; and rejecting the call when the caller id number is determined in the rejection list.

Preferably, in order to receive call by checking valid password, the call handling method further comprises: determining whether the password is valid when the second contact tuple corresponding to the password is found; prompting the user to answer the call when the password is determined valid; and rejecting the call when the password is determined invalid.

Preferably, in order to receive call from family, friend and system category, the category of the first contact tuple includes one of followings: system, family, friend and normal, wherein a password of the first contact tuple is null when the category of the first contact tuple is denoted as system, wherein the password of the first contact tuple is manually inputted by the user when the category of the first contact tuple is denoted as family, wherein the password of the first contact tuple is automatically generated by the user when the category of the first contact tuple is denoted as friend or normal, wherein the password is unique in the filter book.

Preferably, in order to have a mechanism to put an caller id number in the rejection list when the password is missed, the call handling method further comprises following steps after the call is rejected when the second contact tuple corresponding to the password is not found: determining whether a permanent rejection condition is met with a rejection state regarding to the caller id number; adding the caller id number to a rejection list when the permanent rejection condition is met; and updating the rejection state regarding to the caller id number when the permanent rejection condition is not met.

Preferably, in order to have a mechanism to put an caller id number in the rejection list when the password is determined invalid, the call handling method further comprises following steps after the call is rejected after the call is rejected when the password is determined invalid: determining whether a permanent rejection condition is met with a rejection state regarding to the caller id number; adding the caller id number to a rejection list when the permanent rejection condition is met; and updating the rejection state regarding to the caller id number when the permanent rejection condition is not met.

Preferably, in order to conveniently input password via a dial pad of a telephone, the password includes a concatenation of numeric digits.

Preferably, in order to revive an invalid password, the call handling method further comprises: asking the user for setting the password valid when the password is determined invalid; and setting the password valid and prompting the user to answer the call when the user agrees to set the password valid.

Preferably, in order to add a new contact with another instance of filter application, the call handling method further comprises: creating a fourth contact tuple in the filter book, wherein the category of the fourth contact tuple is denoted as normal; generating a fourth password of the fourth contact tuple; transmitting the fourth password of the fourth contact tuple to a second communication apparatus; and receiving an outgoing password of the fourth contact tuple from the second communication apparatus.

According to an embodiment of the present application, a message handling method is provided. The message handling method comprising: receiving a message with a caller id number; searching for a first contact tuple according to the caller id number in a filter book; determining whether a category of the first contact tuple is denoted as normal when the contact tuple is found; and prompting a user with the message when the category of the contact tuple is not denoted as normal.

Preferably, in order to receive message by checking password, the message handling method further comprises: checking for a password in the message when no contact tuple corresponding to the caller id number in the filter book is found; searching for a second contact tuple corresponding to the password in the message in the filter book; prompting the user with the message when the second contact tuple corresponding to the password is found; and ignoring the message when the second contact tuple corresponding to the password is not found.

Preferably, in order to reject a caller id number permanently, the message handling method further comprises: determining whether the caller id number is in a rejection list prior to the searching step; and ignoring the message when the caller id number is determined in the rejection list.

Preferably, in order to receive message by checking valid password, the message handling method further comprises: determining whether the password is valid when the second contact tuple corresponding to the password is found; prompting the user with the message when the password is determined valid; and ignoring the message when the password is determined invalid.

Preferably, in order to receive message from family, friend and system category, the category of the first contact tuple includes one of followings: system, family, friend and normal, wherein a password of the first contact tuple is null when the category of the first contact tuple is denoted as system, wherein the password of the first contact tuple is manually inputted by the user when the category of the first contact tuple is denoted as family, wherein the password of the first contact tuple is automatically generated by the user when the category of the first contact tuple is denoted as friend or normal, wherein the password is unique in the filter book.

Preferably, in order to have a mechanism to put an caller id number in the rejection list when the password is missed, the message handling method further comprises following steps after the message is ignored when the second contact tuple corresponding to the password is not found: determining whether a permanent rejection condition is met with a rejection state regarding to the caller id number; adding the caller id number to a rejection list when the permanent rejection condition is met; and updating the rejection state regarding to the caller id number when the permanent rejection condition is not met.

Preferably, in order to have a mechanism to put an caller id number in the rejection list when the password is determined invalid, the message handling method further comprises following steps after the message is ignored when the password is determined invalid: determining whether a permanent rejection condition is met with a rejection state regarding to the caller id number; adding the caller id number to a rejection list when the permanent rejection condition is met; and updating the rejection state regarding to the caller id number when the permanent rejection condition is not met.

Preferably, in order to conveniently input password via a dial pad of a telephone, the password includes a concatenation of numeric digits.

Preferably, in order to revive an invalid password, the message handling method further comprises: asking the user for setting the password valid when the password is determined invalid; and setting the password valid and prompting the user with the message when the user agrees to set the password valid.

Preferably, in order to add a new contact with another instance of filter application, the message handling method further comprises: creating a fourth contact tuple in the filter book, wherein the category of the fourth contact tuple is denoted as normal; generating a fourth password of the fourth contact tuple; transmitting the fourth password of the fourth contact tuple to a second communication apparatus; and receiving an outgoing password of the fourth contact tuple from the second communication apparatus.

While the invention has been described in terms of what is presently considered to be the most practical and preferred embodiments, it is to be understood that the invention needs not to be limited to the above embodiments. On the contrary, it is intended to cover various modifications and similar arrangements included within the spirit and scope of the appended claims which are to be accorded with the broadest interpretation so as to encompass all such modifications and similar structures.

What is claimed is:

1. A call handling method, comprising:
receiving a notification of a call with a caller id number;
searching for a first contact tuple corresponding to the caller id number in a filter book;
determining whether a category of the first contact tuple is denoted as normal when the contact tuple is found; and
prompting a user to answer the call when the category of the contact tuple is not denoted as normal.

2. The call handling method as claimed in claim 1, further comprises:
asking a caller for a password when no contact tuple corresponding to the caller id number in the filter book is found;
searching for a second contact tuple corresponding to the password from the caller in the filter book;
prompting the user to answer the call when the second contact tuple corresponding to the password is found; and
rejecting the call when the second contact tuple corresponding to the password is not found.

3. The call handling method as claimed in claim 1, further comprises:
determining whether the caller id number is in a rejection list prior to the searching step; and
rejecting the call when the caller id number is determined in the rejection list.

4. The call handling method as claimed in claim 2, further comprises:
determining whether the password is valid when the second contact tuple corresponding to the password is found;
prompting the user to answer the call when the password is determined valid; and
rejecting the call when the password is determined invalid.

5. The call handling method as claimed in claim 1, wherein the category of the first contact tuple includes one of followings: system, family, friend and normal,
wherein a password of the first contact tuple is null when the category of the first contact tuple is denoted as system,
wherein the password of the first contact tuple is manually inputted by the user when the category of the first contact tuple is denoted as family,
wherein the password of the first contact tuple is automatically generated by the user when the category of the first contact tuple is denoted as friend or normal,
wherein the password is unique in the filter book.

6. The call handling method as claimed in claim 2, further comprises following steps after the call is rejected when the second contact tuple corresponding to the password is not found:
determining whether a permanent rejection condition is met with a rejection state regarding to the caller id number;
adding the caller id number to a rejection list when the permanent rejection condition is met; and
updating the rejection state regarding to the caller id number when the permanent rejection condition is not met.

7. The call handling method as claimed in claim 4, further comprises following steps after the call is rejected when the password is determined invalid:
determining whether a permanent rejection condition is met with a rejection state regarding to the caller id number;
adding the caller id number to a rejection list when the permanent rejection condition is met; and
updating the rejection state regarding to the caller id number when the permanent rejection condition is not met.

8. The call handling method as claimed in claim 2, wherein the password includes a concatenation of numeric digits.

9. The call handling method as claimed in claim 4, further comprises:
asking the user for setting the password valid when the password is determined invalid; and
setting the password valid and prompting the user to answer the call when the user agrees to set the password valid.

10. The call handling method as claimed in claim 1, further comprises:
creating a fourth contact tuple in the filter book, wherein the category of the fourth contact tuple is denoted as normal;
generating a fourth password of the fourth contact tuple;
transmitting the fourth password of the fourth contact tuple to a second communication apparatus; and
receiving an outgoing password of the fourth contact tuple from the second communication apparatus.

11. A message handling method, comprising:
receiving a message with a caller id number;
searching for a first contact tuple according to the caller id number in a filter book;
determining whether a category of the first contact tuple is denoted as normal when the contact tuple is found; and
prompting a user with the message when the category of the contact tuple is not denoted as normal.

12. The message handling method as claimed in claim 11, further comprises:
checking for a password in the message when no contact tuple corresponding to the caller id number in the filter book is found;
searching for a second contact tuple corresponding to the password in the message in the filter book;
prompting the user with the message when the second contact tuple corresponding to the password is found; and
ignoring the message when the second contact tuple corresponding to the password is not found.

13. The message handling method as claimed in claim 11, further comprises:
determining whether the caller id number is in a rejection list prior to the searching step; and
ignoring the message when the caller id number is determined in the rejection list.

14. The message handling method as claimed in claim 12, further comprises:
determining whether the password is valid when the second contact tuple corresponding to the password is found;
prompting the user with the message when the password is determined valid; and
ignoring the message when the password is determined invalid.

15. The message handling method as claimed in claim 11, wherein the category of the first contact tuple includes one of followings: system, family, friend and normal,
wherein a password of the first contact tuple is null when the category of the first contact tuple is denoted as system,
wherein the password of the first contact tuple is manually inputted by the user when the category of the first contact tuple is denoted as family,
wherein the password of the first contact tuple is automatically generated by the user when the category of the first contact tuple is denoted as friend or normal,
wherein the password is unique in the filter book.

16. The message handling method as claimed in claim 12, further comprises following steps after the message is ignored when the second contact tuple corresponding to the password is not found:
determining whether a permanent rejection condition is met with a rejection state regarding to the caller id number;
adding the caller id number to a rejection list when the permanent rejection condition is met; and
updating the rejection state regarding to the caller id number when the permanent rejection condition is not met.

17. The message handling method as claimed in claim 14, further comprises following steps after the message is ignored when the password is determined invalid:
determining whether a permanent rejection condition is met with a rejection state regarding to the caller id number;
adding the caller id number to a rejection list when the permanent rejection condition is met; and
updating the rejection state regarding to the caller id number when the permanent rejection condition is not met.

18. The message handling method as claimed in claim 12, wherein the password includes a concatenation of numeric digits.

19. The message handling method as claimed in claim 12, further comprises:
asking the user for setting the password valid when the password is determined invalid; and
setting the password valid and prompting the user with the message when the user agrees to set the password valid.

20. The message handling method as claimed in claim 11, further comprises:
creating a fourth contact tuple in the filter book, wherein the category of the fourth contact tuple is denoted as normal;
generating a fourth password of the fourth contact tuple;
transmitting the fourth password of the fourth contact tuple to a second communication apparatus; and
receiving an outgoing password of the fourth contact tuple from the second communication apparatus.
